(19) United States
(12) Patent Application Publication
(10) Pub. No.: US 2022/0114523 A1
(43) Pub. Date: Apr. 14, 2022

(54) Profit Enhancer Analysis

(71) Applicant: Natasha Elaine Davis, Snellville, GA (US)

(72) Inventor: Natasha Elaine Davis, Snellville, GA (US)

(21) Appl. No.: 17/352,455

(22) Filed: Jun. 21, 2021

Related U.S. Application Data
(60) Provisional application No. 63/023,922, filed on Jun. 23, 2020.

(51) Int. Cl. G06Q 10/06; G06F 3/0482

(52) U.S. Cl. CPC G06Q 10/06375; G06F 3/0482; G06Q 10/06393

(57) ABSTRACT

The Profit Enhancer Analysis aka The Profit Enhancer aka The PEA is a cloud-based predictive model diagnostic business and productivity Software as a service (SaaS) tool for customer relationship management. The software application decodes data entered using proprietary calculations and algorithms to provide a detailed, customized assessment of a clients business performance. It offers the user insight to be able to understand client historical behavior trends and is used as a new client qualifier as well as an identifier of specific performance gaps of a company as well as overall health of the company.

Through the use of The Profit Enhancer Analysis, the user will have further the ability to send proposals immediately after a consultation and have insight and details to evaluate product performance, service performance and department performance of a client. The user which is a professional consultant has the ability to make fact based and evidenced based decisions for each client based on qualitative and quantitative data.

The Profit Enhancer Analysis is a cloud-based software that can be accessed on any device desktop, laptop, tablet or mobile phone at anytime to view real time information. The Profit Enhancer will have a companion app with the same features and functionality that will be accessible on Android and Apple platforms. The Profit Enhancer Analysis website and software is on www.ProfitEnhancerAnalysis.com.

The Profit Enhancer Analysis {PEA} is a cloud based predictive model diagnostic business and productivity Software as a service (SaaS) tool for customer relationship management. The interchangeable names of the SaaS are The PEA and The Profit Enhancer. It is accessed for the purposes of initial evaluation of the prospective client during a consultation and then is used for ongoing management of the client and plan of action for service management. This SaaS is a business and productivity software for the purposes of customer relationship management. Some additional features of The Profit Enhancer Analysis aka The Profit Enhancer is that the user has the ability to develop proposals for service delivery at the time of the consultation to be sent electronically to the prospective client for acceptance or declination of service. The Profit Enhancer has an internal community for active users to communicate directly with one another as a resource and referral source. The Profit Enhancer Analysis collects pertinent industry data that will be available for industry research purposes.

The Profit Enhancer Analysis software evaluates five (5) distinct business operational sections by decoding the data through the use of the proprietary calculations and algorithms created by the inventor, Natasha Elaine Davis and then renders a category weighted score communicated in percentage format. The specific business operational sections are 1) Business Development 2) Financial Ability 3) Marketing 4) Human & Social Capital 5) Technology

Each business operational section has a weighted percentage referred to as Category Weight % aka CW % and that CW percentage is used to assess the specific performance gaps within that business operational section. Each business operational section category weighted percentage is then combined and calculated upon completion of the assessment to deliver a comprehensive score in percentage format which is referred to as the Profit Index Score aka PI Score.

The initial Profit Index Score is used to offer a comprehensive assessment of the company's health and position for Growth, Profitability and Sustainability aka the GPS. The PI Score expressed in percentage (%) provides the consultant guidance on the decision to accept or decline the prospective client for service during the consultation. Once the prospect is accepted by the consultant as a client, subsequent PI Scores are used to assess the progress and growth during scheduled intervals of weeks or months depending on the users' business model for service delivery.

The ideal initial PI Score is set at 72% and the minimum score used as the client qualifying threshold point is a PI Score of 32% to 35%. {FIG. 4, FIG. 17}. The goal is for the user to provide appropriate levels of service and support to assist the client to achieve a PI Score of 72% to 90% by Milestone Check Interval Assessment #4 and onward.

These are the Five (5) Distinct Business Operational Sections Evaluated by the Profit Enhancer Analysis and each Section has its own Category Weight %. {FIG. 18}
Business Development evaluates the companies strategic plan matched to their actions, behavior patterns and the business model. This department category carries a total maximum category weight goal of 20% and a minimum total category weight goal of 15% {FIG. 6}
Financial Ability evaluates the companies financial goals, actual & expectations regarding revenue generating activity and profit margins. This department category carries a total maximum category weight goal of 28% and a minimum total category weight goal of 22% {FIG. 7}
Marketing evaluates the companies touch points, industry positioning and marketing Return On Investment against their client acquisition trends. This department category carries a total maximum category weight goal of 20% and a minimum total category weight goal of 15% {FIG. 8}
Human & Social Capital evaluates the companies team structure, behavior, customer retention and engagement rates. This department category carries a total maximum category weight goal of 22% and a minimum total category weight goal of 14% {FIG. 9}
Technology evaluates the companies ability to streamline processes and leverage technology for industry positioning as well as efficiency. This department category carries a total maximum category weight goal of 10% and a minimum total category weight goal of 6% {FIG. 10}

The Profit Enhancer Analysis is conducted as the primary assessment termed Initial Assessment of a prospect and then as scheduled Milestone Check Interval Assessments of active clients to evaluate the current progress, growth, resolution and position of the client expressed in category weight % and profit index score % for each assessment.

The consultant will schedule subsequent MCI Assessments within The PEA software upon completion of each assessment. {FIG. 5} The PEA assessment intervals are as follows:
Initial Assessment—Performed during the initial consultation. Used to determine acceptance of the client as well as overall company performance gaps and position for Growth Profitability and Sustainability. This is used to develop the specific plan of action for the potential customer and to also provide a proposal quote to the prospective client.
Milestone Check Interval {MCI} Assessment #1—Performed at 3 weeks or 3 months of service initiation. CW % and PI Score used to assess progress since initiating service.
Milestone Check Interval {MCI} Assessment #2—Performed at 6 weeks or 6 months of service initiation. CW % and PI Score used to assess progress since initiating service.
Milestone Check Interval {MCI} Assessment #3—Performed at 9 weeks or 9 months of service initiation. CW % and PI Score used to assess progress since initiating service.
Milestone Check Interval {MCI} Assessment #4—Performed at 12 weeks or 12 months of service initiation. CW % and PI Score used to assess progress since initiating service.
Milestone Check Interval {MCI} Assessment #5 & up—Referred to as renewal term is performed after 12 weeks or 12 months of service initiation for ongoing client management. CW % and PI Score used to assess ongoing and continued progress since initiating service at same scheduled intervals of 3, 6, 9, 12.

The Profit Enhancer Analysis uses one quarters worth of the client company data to be inputted for evaluation, decoding and calculation for the initial assessment and ongoing assessments.

The PEA relies on actual data and facts, via qualitative and quantitative data specific to the company not guess work or generalized industry data.

The Profit Enhancer is designed to be used in any industry and any company size. The Profit Enhancer Analysis is designed to easily and conveniently work synergistically with other business management software tools, Customer Relationship Management (CRM) software tools and project management tools for the purposes of importing client demographic data through basic data importing. The software is cloud-based and is accessible at anytime in real-time on a desktop, laptop, tablet or mobile phone.

Invention Proprietary Calculations and Algorithms: Business Operational Categories {FIGS. 6, 7, 8, 9, 10}

Business Development: (This Reflects Behavior Patterns, Trends and Usage of a Strategic Plan)—Category Weight % Goal is 15-20%

Questions are a yes or a no . . . except listed below

1) Is there a Business Growth Plan in Place?—Yes or No option to be selected (The Yes option selected will award 4 points or 4% . . . The No option will deduct 4 points aka 4% from the whole category)

2) Is Research & Development used and applied?—Yes or No option to be selected (The Yes option selected will award 4 points or 4% . . . The No option will deduct 4 points aka 4% from the whole category)

3) Is there an Active and Current Business Model used?—Yes or No option to be selected (The Yes option selected will award 4 points or 4% . . . The No option will deduct 4 points aka 4% from the whole category)

4) Determine Industry/Product Knowledge (proprietary calculations)

Number of Years in the Industry ______

Number of Years in Operation ______

The Application Decodes Data Entered as follows:

Years in the Industry/Years in Operation=Ratio . . . The intent is that there is a 50/50 ratio to earn full 4 points aka 4%)

5) Determine the Professional Development: (proprietary calculations)

Yes or No option to be selected (this entire question is worth 4% HOWEVER, each question below contributes to the total 4% . . . Answer Yes and 1% is earned towards the 4%
Is the client Certified in their industry?=Yes=1% or No=0%
Does the Client have Written professional published literature?=Yes=1% or No=0%
Does the client engage in Professional Speaking on their topic as SME? Yes=1% or No=0%
Does the client have Academic Degrees in the profession (bachelors or masters)? Yes=1% or No=0%

Financial Ability: (this Reflects a Portion of Behavior Trends and Profitability Trends)—Category Weight % Goal is 22-28%

These are Yes or No Q & A (however cross checked with each clients financial reports)

1) Does the client have firm pricing strategy—Yes or No option to be selected (The Yes option selected will award 5.60 points or 5.60% . . . The No option will deduct 5.60 points aka 5.60% from the whole category)

2) Does the client demonstrate a minimum Profit Margin of 10%—Yes or No option to be selected (The Yes option selected will award 5.60 points or 5.60% . . . The No option will deduct 5.60 points aka 5.60% from the whole category)

3) Does the client demonstrate consistent revenue activity each month? Yes or No option to be selected (The Yes option selected will award 5.60 points or 5.60% . . . The No option will deduct 5.60 points aka 5.60% from the whole category)

4) Does the client demonstrate a ROI of at least 20%? Yes or No option to be selected (The Yes option selected will award 5.60 points or 5.60% . . . The No option will deduct 5.60 points aka 5.60% from the whole category)

5) Does the client demonstrate new business close rate of 10% OR <20 day conversion? Yes or No option to be selected (The Yes option selected will award 5.60 points or 5.60% . . . The No option will deduct 5.60 points aka 5.60% from the whole category)

Marketing: (This Reflects Client Acquisition, Industry Position & Growth Trends) Category Weight % Goal is 15-20%

Question are a Yes or a No . the others have specific behind the scenes calculations to be accounted for

1) Does the client have an active Customer Relationship Management (CRM) system and model?—Yes or No option to be selected (The Yes option selected will award 4 points or 4% . . . The No option will deduct 4 points aka 4% from the whole category)

2) Does the client have strong and active Touch Point strategies?—The select the square but then they only select one of the circles. (The Yes option selected will award 4 points or 4% . . . The No option will deduct 4 points aka 4% from the whole category)

Options to be available for Selection:
5 or more active consistently used
2 to 4 active consistently used
less than 2 active consistently used

(Application Decodes Data entered as follows:)

Touchpoints:
If 5 or more active consistently used touch points earns full 4%
If less than 5 active consistently used touch points deduct 2%
If less than 2 active consistently used touch points 0% earned

3) Does the client have an active and current Marketing Plan of Action in place?—Yes or No option to be selected (The Yes option selected will award 4 points or 4% . . . The No option will deduct 4 points aka 4% from the whole category)

4) Determine the clients Brand and Industry Position?
a) Has the client/company been awarded as a Subject Matter Expert? Yes or No Option
b) Does the client receive a minimum of 2 solid referrals per month? Yes or No Option

(Application Decodes Data entered as follows:)
Awarded as a SME or Company awarded? Yes=2%
Referral Ratio per quarter ? (If greater than 2 solid referrals per month. Yes=2%

5) Determine the clients Active Social-Local-Mobile position:

(These Questions are to have Yes or No Options available)
a) Does the client have 3 or more actively engaged social media platforms with at least 500 followers?
b) Does the client host or speak as a minimum of two business events per quarter?
c) Does the client/company have an App or Online interactive platform for customers?

(Application Decodes Data entered as follows:)
3 or more active social media platforms used with at least 500 followers? Yes=1.5%
Hosts or Speaks at two business events per quarter? Yes=1.5%
Has a company APP or Online Interactive platform? Yes=1%

Human & Social Capital: (this Reflects Sustainability Trends)—Category Weight % Goal is 14-22%

Question are a yes or a no . . . except listed below

1) Does the client have a dual team structure? {A Planning Team and a Doing Team}—Yes or No option to be selected (The Yes option selected will award 3.60 points or 3.60% . . . The No option will deduct 3.60 points aka 3.60% from the whole category)

2) Does the client have active Sponsors or Investors? Yes or No option to be selected (The Yes option selected will award 3.60 points or 3.60% . . . The No option will deduct 3.60 points aka 3.60% from the whole category)

3) Does the client have active Promotion Partners? Yes or No option to be selected (The Yes option selected will award 3.60 points or 3.60% . . . The No option will deduct 3.60 points aka 3.60% from the whole category)

4) Does the client have consistent clients each month? Yes or No option to be selected (The Yes option selected will award 3.60 points or 3.60% . . . The No option will deduct 3.60 points aka 3.60% from the whole category)

5) Determine the clients Engagement Rate (The Goal for this specific question is 8%)

(Each Question is a to have a Yes or No Option to Answer)

a) Is the client's Customer Lifetime Value showing at least 2 buys per year/per customer?

b) Is the client's Email Open Rate at least 18%?

c) Is the client's Social Media PTAT 3% are higher?

d) Is the client's Retention Rate or Stability Index at least 40% or higher?

Engagement Rates of 8% is the goal: (proprietary calculations)

(Application Decodes Data entered as follows:)

Each of the below Areas are worth 2% points
Customer Lifetime Value Rate (At least 2 buys per year/per customer) this earns the 2%
Email Open Rate 18% is good—this earns the 2%
Social Media PTAT of 3% is good—this earns the 2%
Retention Rate/Stability Index in % (less than 40% bad)-greater than 40% earns the 2%

6) Does the client demonstrate social proof and/or customer testimonials? (The Yes option selected will award 3.60 points or 3.60% . . . The No option will deduct 3.60 points aka 3.60% from the whole category)

Technology (Reflects Ability to be Streamlined & Efficient while Leveraging Technology)—Category Weight % Goal 6-10%

Question are a yes or a no

1) Does the client demonstrate easy online search-ability? (The Yes option selected will award 3.30 points or 3.30% . . . The No option will deduct 3.30 points aka 3.30% from the whole category)

2) Does the client's website have strong SEO and site visits? (The Yes option selected will award 3.30 points or 3.30% . . . The No option will deduct 3.30 points aka 3.30% from the whole category)

3) Does the client use technology and software to streamline daily operations? (The Yes option selected will award 3.30 points or 3.30% . . . The No option will deduct 3.30 points aka 3.30% from the whole category)

### DESCRIPTION OF DRAWINGS

FIG. 1A—is the drawing image representing the company logo

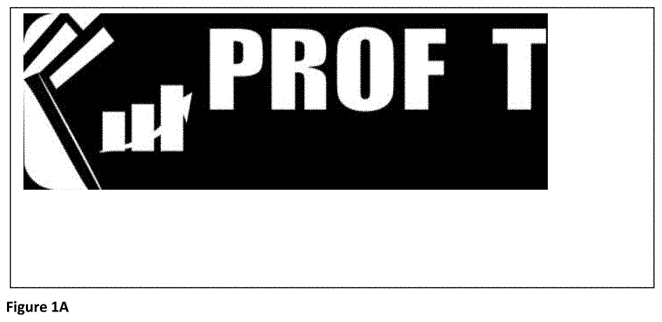

FIG. 1—is the drawing representing the home login screen

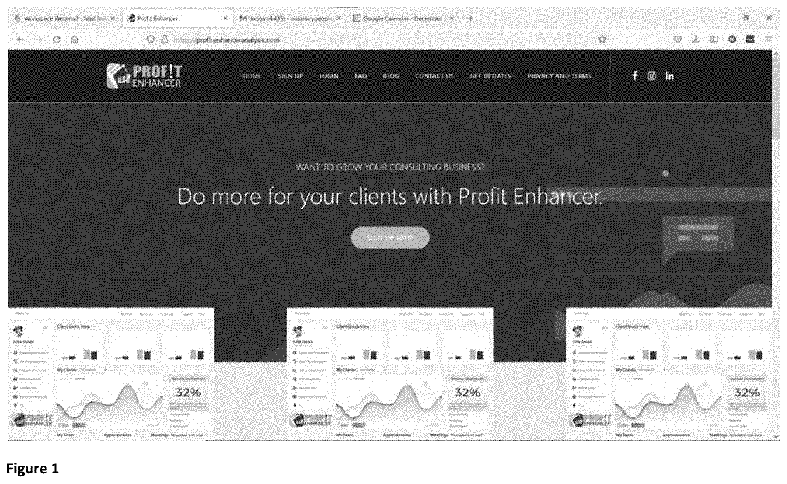

FIG. 2—is the drawing representing the client quick view dashboard

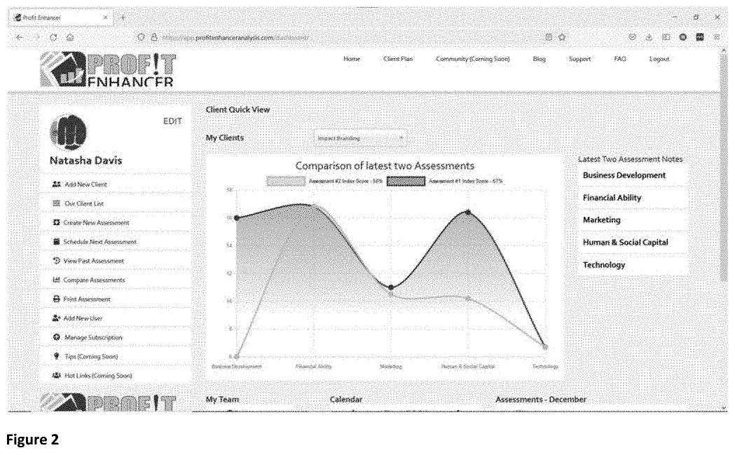

FIG. 3—is the drawing representing the compare assessment view

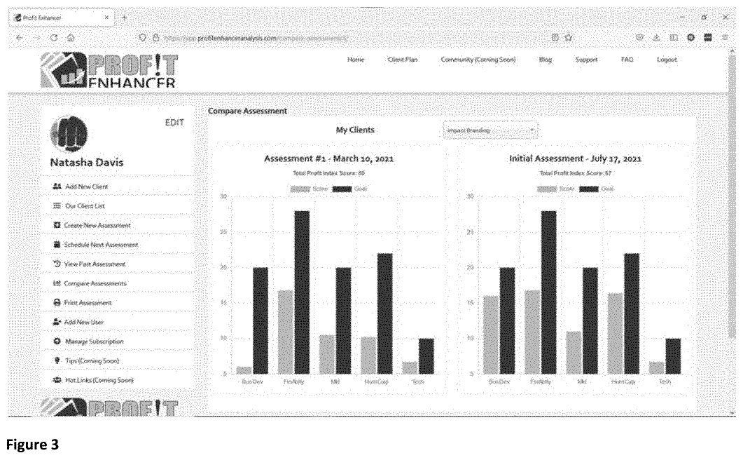

FIG. 4—is the drawing representing the index score graph view

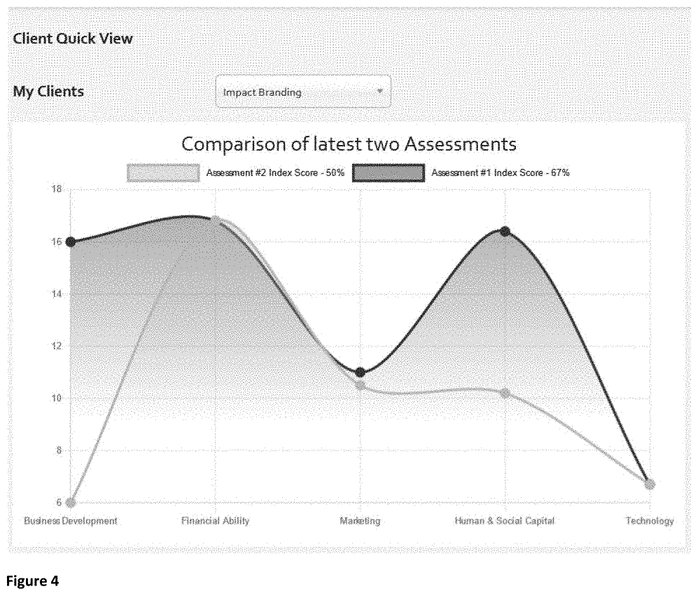

FIG. 5—is the drawing representing the create new appointment dashboard

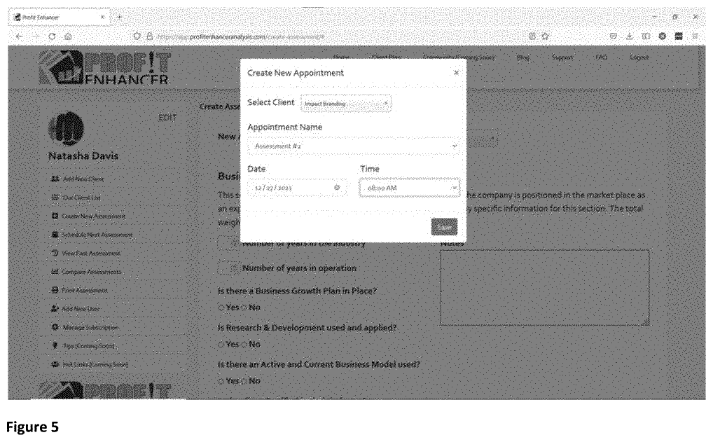

FIG. 6—is the drawing representing the create new assessment dashboard view 1

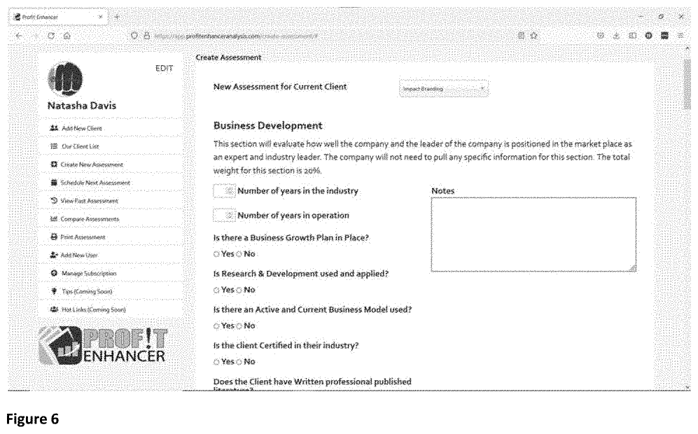

FIG. 7—is the drawing representing the create new assessment dashboard view 2

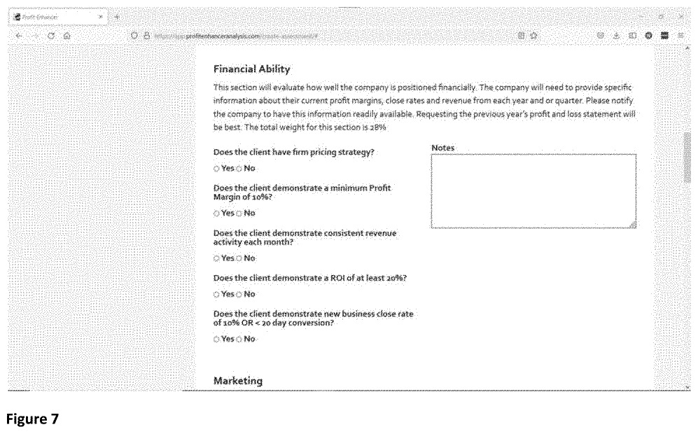

FIG. 8—is the drawing representing the create new assessment dashboard view 3

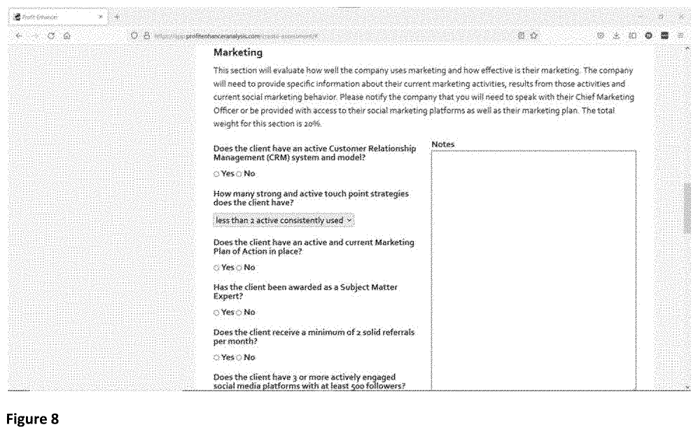

FIG. 9—is the drawing representing the create new assessment dashboard view 4

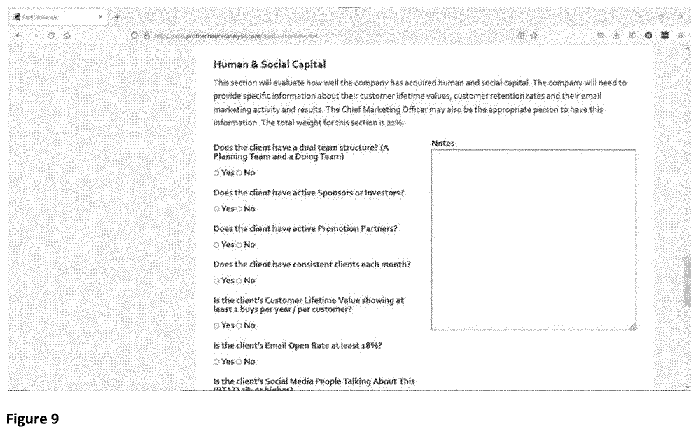

FIG. 10—is the drawing representing the create new assessment dashboard view 5

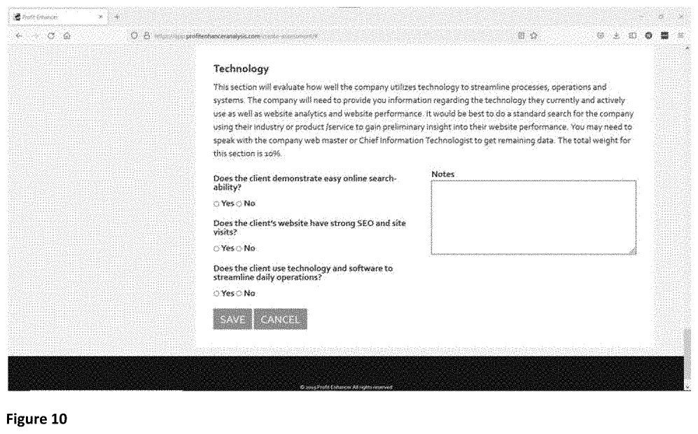

FIG. 11—is the drawing representing the view completed assessment dashboard 1

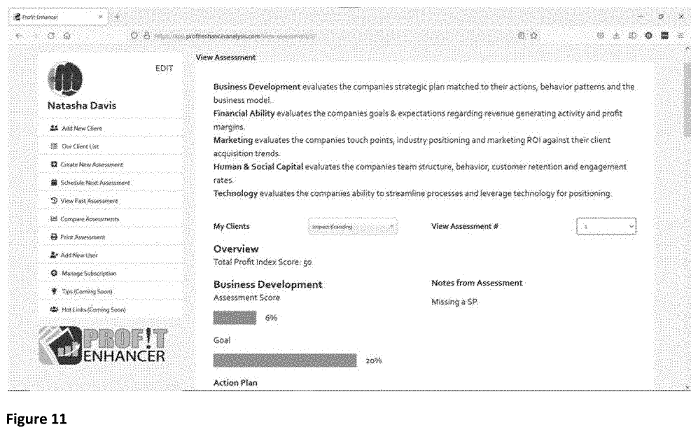

FIG. 12—is the drawing representing the view completed assessment dashboard 2

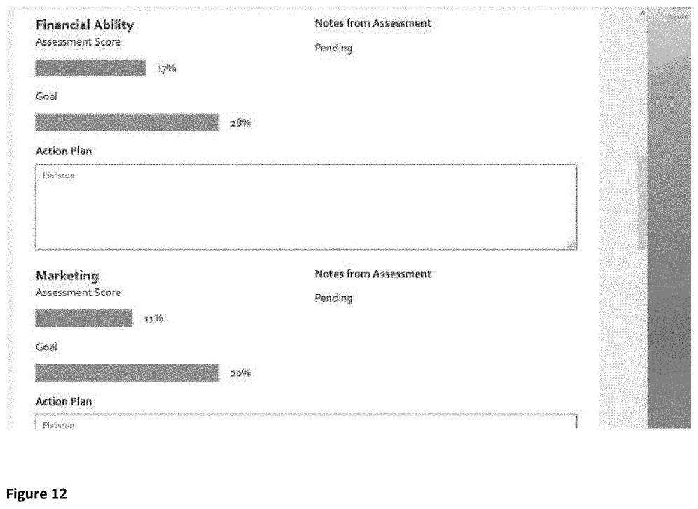

FIG. 13—is the drawing representing the view completed assessment dashboard 3

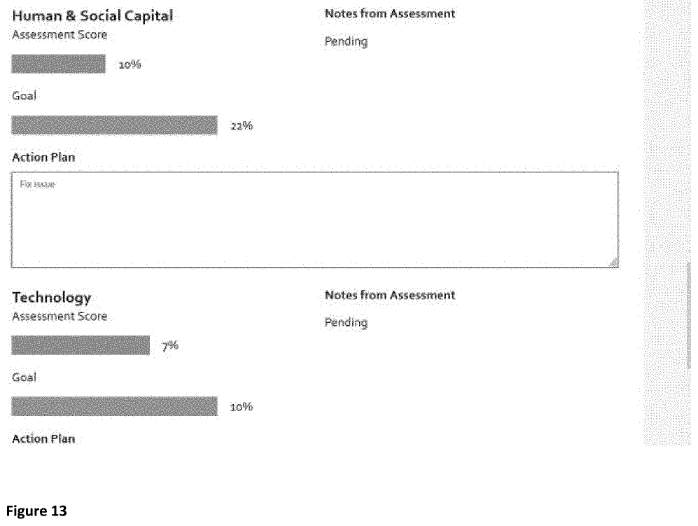

FIG. 14—is the drawing representing the view completed assessment dashboard 4

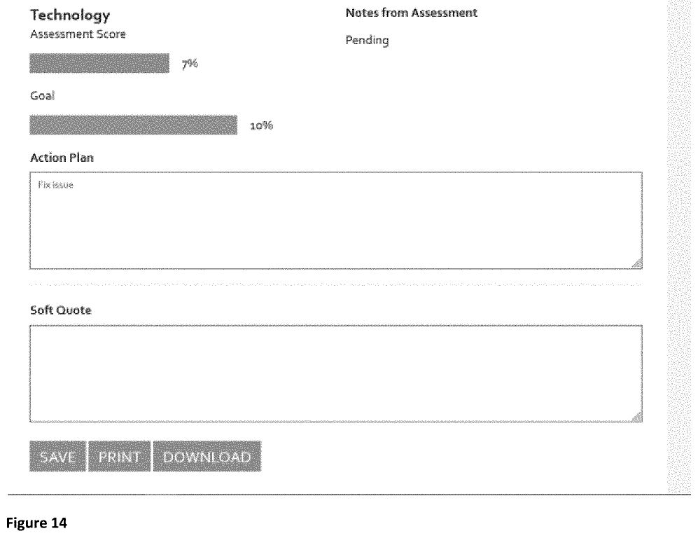

FIG. 15—is the drawing representing the manage client dashboard

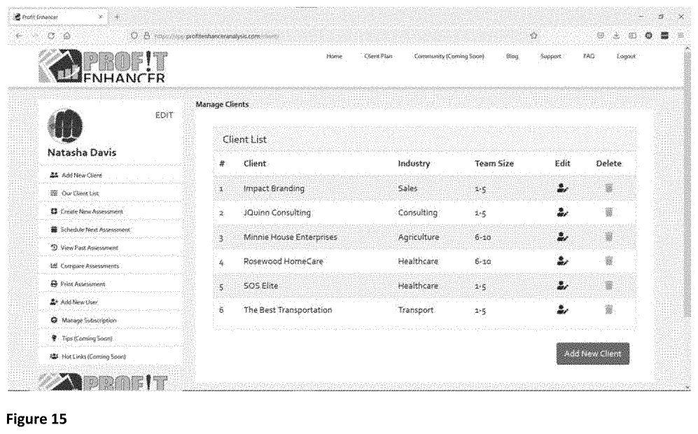

FIG. 16—is the drawing representing the add new client dashboard

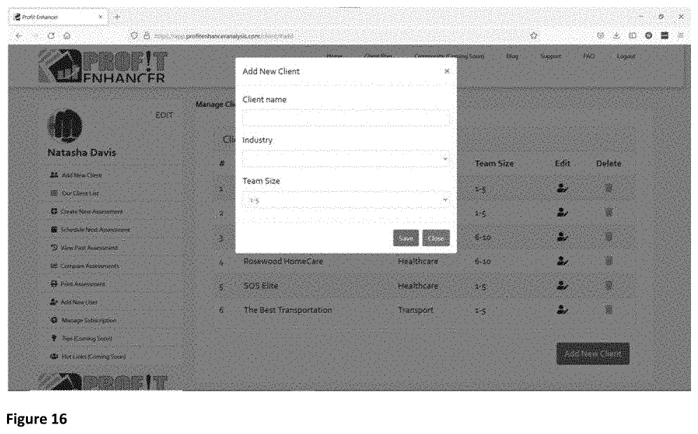

FIG. 17—is the drawing representing the index score bar graph view

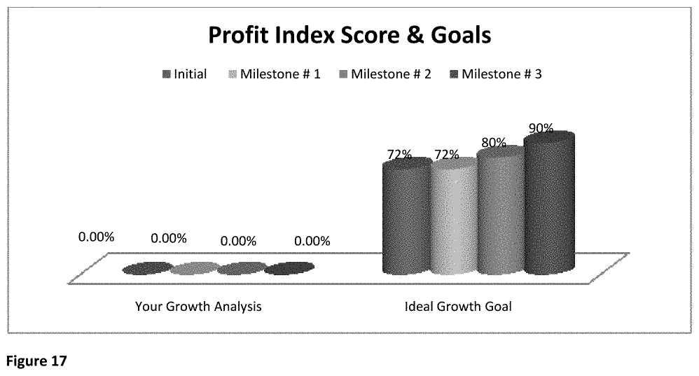

FIG. 18—is the drawing representing the category weighted percentage view

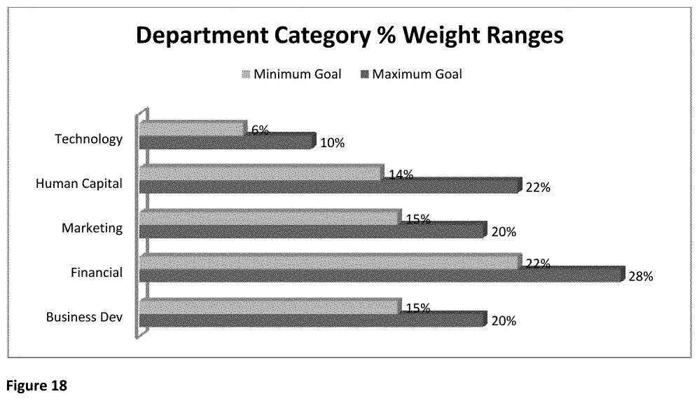

1.—A METHOD FOR COMPLETING AN ASSESSMENT, comprising:
a main section of at least five questions;
a sub-section within each main section of at least three questions;
a decoding of data of each question within each sub-section within each main section; and
a decoding of data of each main section, characterized in that,
a final determination is completed to support the total assessment from each main section represented in percentage format is the programmable means for completing the assessment.

2.—A METHOD FOR COMPLETING AN ASSESSMENT as in claim 1 wherein said sub-section within each main section of each question produces a percentage is the programmable means for determining the weighted percentage of each main section.

3.—A METHOD FOR COMPLETING AN ASSESSMENT as in claim 2 wherein said main section of questions produces a percentage is the programmable means for determining the final weighted percentage for the total assessment.

4.—A METHOD FOR DETERMINING BUSINESS DEVELOPMENT PERFORMANCE consisting essentially of:
responding to two specific questions within a sub-section of a main section;
system application receives data entered;
system application decodes data; and
determines a specific percentage earned from each response,
characterized in that, this is the programmable means for contributing to determining the weighted percentage for the specific question within a sub-section of a main section.

5.—A METHOD FOR DETERMINING PROFESSIONAL DEVELOPMENT PERFORMANCE consisting essentially of:
responding to four specific questions within a sub-section of a main section;
system application receives data entered;
system decodes data; and
determines a specific percentage earned from each question,
characterized in that, this is the programmable means for contributing to determining the weighted percentage for the specific question within a sub-section of a main section.

6.—A METHOD FOR DETERMINING ENGAGEMENT RATES PERFORMANCE consisting essentially of:
responding to four specific questions within a sub-section of a main section;
system application receives data entered;
system decodes data; and
determines a specific percentage earned from each question,
characterized in that, this is the programmable means for contributing to determining the weighted percentage for the specific question within a sub-section of a main section.
